(19) United States
(12) Patent Application Publication
(10) Pub. No.: US 2017/0111703 A1
(43) Pub. Date: Apr. 20, 2017

(54) Device And Method For No-Signal Processing Of Television And Smart Television

(71) Applicant: HISENSE ELECTRIC CO., LTD., Qingdao (CN)

(72) Inventor: Yongjian ZHAO, Qingdao (CN)

(21) Appl. No.: 15/393,741

(22) Filed: Dec. 29, 2016

(30) Foreign Application Priority Data
Jun. 22, 2016 (CN) 201610460715.4

(51) Int. Cl. H04N 21/485; G09G 3/00; H04N 21/442; H04N 21/472; H04N 21/482

(52) U.S. Cl. CPC H04N 21/485; H04N 21/47202; H04N 21/4826; H04N 21/44209; G09G 3/006; G09G 2320/046; G09G 3/36

(57) ABSTRACT

Disclosed are a device and method for no-signal processing and a smart television. The method for no-signal processing of a television includes: sending a request for obtaining program list information to a network side when a first program that is being played by a television shows “no signal state”, the request at least carries identification information of the first program that is played by the television before no signal; receiving and displaying the program list information sent by the network side, the program list information is program information determined by the network side according to the identification information and related to the first program that is played by the television before no signal; and determining a target program in the program list information selected by a user, or selecting the target program in the program list information according to a selecting strategy, and switching to and playing the target program.

### CROSS-REFERENCE TO RELATED APPLICATION

This application claims benefit and priority of Chinese Patent Application No. 201610460715.4 filed Jun. 22, 2016. The entire disclosure of the above application is incorporated herein by reference.

### FIELD

The present disclosure relates to the technical field of displaying, in particular to a device and method for no-signal processing of television and a smart television.

### BACKGROUND

This section provides background information related to the present disclosure which is not necessarily prior art.

With continuous development of television technology, a television has more and more functions, and there are more and more types of televisions. With continuous refinement of television functions, the operation of a smart television also gradually tends to be humanized.

When watching a television program, a user will encounter a situation of no signal caused by weak signals, and at that time, the words “no signal” will be displayed in a liquid crystal display television. Further, in order to prevent a screen burn-in problem caused by long-time displaying of a still picture, “no signal” will also be presented on a television screen in a dynamic floating displaying mode. In this state, the selection of the user is nothing more than switching to the next channel, or waiting, and if the next channel still has no signal or still has no signal after waiting for a period of time, the user is likely to turn off the television and stop using television services.

When a no-signal standby state happens, a background program is set to monitor signal changes; when a watched channel enters into a no-signal state, built-in pictures or videos in a television are played; meanwhile, the signal of the current channel is monitored, and when the signal of the channel is restored, the television stops playing the pictures or the videos and begins to play the contents of the channel continuously.

### SUMMARY

This section provides a general summary of the disclosure, and is not a comprehensive disclosure of its full scope or all of its features.

Some embodiments of this disclosure provide a device for no-signal processing of a television, and the device includes:

a sending unit configured to send a request for obtaining program list information to a network side when a first program that is being played by a television is in a no-signal state, wherein the request at least carries identification information of the first program that is played by the television before no signal;

a receiving unit configured to receive and display the program list information sent by the network side, wherein the program list information is program information determined by the network side according to the identification information and related to the first program that is played by the television before no signal; and

a displaying unit configured to determine a target program in the program list information selected by a user, or selecting a target program in the program list information according to a selecting strategy, and switch to and play the target program.

Some embodiments of this disclosure provide another device for no-signal processing of a television, and the device includes:

a storage storing a computer readable program and at least one processor, wherein the at least one processor executes the computer readable program to:

send a request for obtaining program list information to a network side when a first program that is being played by a television is in a no-signal state, wherein the request at least carries identification information of the program that is played by the television before no signal;

receive and display the program list information sent by the network side, wherein the program list information is program information determined by the network side according to the identification information and related to the first program that is played by the television before no signal; and

determine a target program in the program list information selected by a user, or select a target program in the program list information according to a selecting strategy, and switch to and play the target program.

Some embodiments of this disclosure provide a no signal processing method for a television, including:

sending a request for obtaining program list information to a network side when a first program that is being played by a television is in a no-signal state, wherein the request at least carries identification information of the first program that is played by the television before no signal;

receiving and displaying the program list information sent by the network side, wherein the program list information is program information determined by the network side according to the identification information and related to the first program that is played by the television before no signal; and

determining a target program in the program list information selected by a user, or selecting a target program in the program list information according to a selecting strategy, and switching to and playing the target program.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram of a flow of a method for no-signal processing of a television, provided by some embodiments of this disclosure;

FIG. 2 is a schematic diagram of a no-signal prompt interface of a television, according to some embodiments of this disclosure;

FIG. 3 is a schematic diagram of another no-signal prompt interface of a television, according to some embodiments of this disclosure;

FIG. 4 is a schematic diagram of a flow of a second method for no-signal processing of a television, according to some embodiments of this disclosure;

FIG. 5 is a schematic diagram of a flow of a third method for no-signal processing of a television, according to some embodiments of this disclosure; and

FIG. 6 is a schematic diagram of a structure of a device for no-signal processing of a television, according to some embodiments of this disclosure.

Corresponding reference numerals indicate corresponding parts or features throughout the several views of the drawings.

### DETAILED DESCRIPTION

Example embodiments will now be described more fully with reference to the accompanying drawings.

Referring to FIG. 1, a method for no-signal processing of a television, according to some embodiments of this disclosure, includes:

S101: sending a request for obtaining program list information to a network side when a program that is being played by a television shows “no signal”, wherein the request at least carries identification information of the program that is played by the television before no signal;

It should be noted that the identification information of the program that is played by the television before no signal may include a name of the program that is being played, or a channel of playing and other information, which is not specifically defined therein. For example, when a program that is being played by the television is “PROGRAM 1” in a channel “CHANNEL 1”, the request for obtaining the program list information sent by the television needs to at least carry identification information of “PROGRAM 1”. In order to further determine a program or a channel of interest to a user, the identification information may also carry a channel or a name of a program that is being watched, thus facilitating determination of contents of interest to a user.

In some embodiments, the way of determining identification information by a television may be obtaining from information of an electronic program guide (EPG) of a channel that is being played by the television, or obtaining in other ways, which is not specifically defined herein.

S102: receiving and displaying the program list information sent by the network side, wherein the program list information is program information determined by the network side according to the identification information and related to the program that is played by the television before no signal;

In some embodiments, after receiving the request carrying identification information, the network side will generate a program list related to program names determined in the identification information according to the identification information. For example, if the identification information is “PROGRAM 1”, then the program list information may include: programs of each episode of “PROGRAM 1”, various trailers of “PROGRAM 1”, and related programs of main actors in “PROGRAM 1”. Where, the program list information is not specifically defined in embodiments of this disclosure, and may be pushed according to actual conditions.

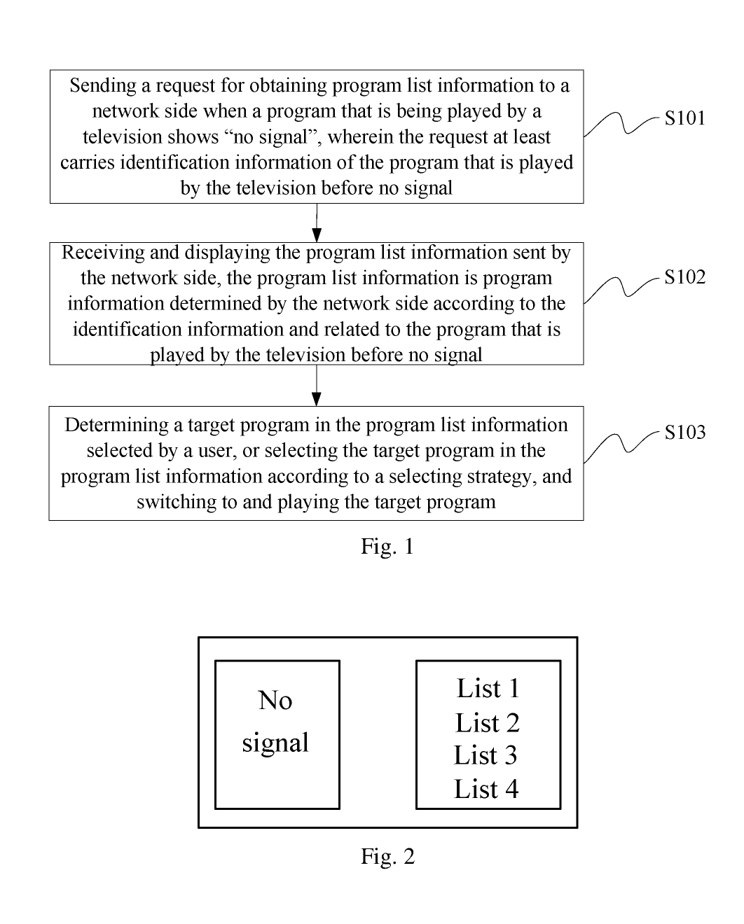

The network side, after determining the program list information, sends the program list information to a television, and then the television displays the program list information. Where, the way of displaying the program list information by the television is not specifically defined herein. For example, the program list information and a no-signal state may be displayed on a screen of the television at the same time, or only the program list information may be displayed on the screen of the television. In some embodiments, as shown in FIG. 2, the left side in a display interface of the television is for a no-signal state, the right side is an interface for the program list information, and a user may select by virtue of left and right keys of a remote controller, wherein the program list information includes a program 1, a program 2, a program 3 and a program 4, and the programs may be arranged according to correlations with the program that is played by the television before no signal from high to low, i.e., a list 1 represents a program having a highest correlation with the program that is played by the television before no signal, a list 2 represents a program having a higher correlation with the program that is played by the television before no signal, a list 3 represents a program having a lower correlation with the program that is played by the television before no signal, and a list 4 represents a program having a lowest correlation with the program that is played by the television before no signal. Certainly, the program list information may include multiple programs but not limited to four programs. Naturally, the way of displaying the program list information by the television may be the way provided in FIG. 2, also may be other forms adopted to display the program list information, and as long as the ways can provide an interface for selection by a user, they fall within the scope of protection of this disclosure.

S103: determining a target program in the program list information selected by a user, or selecting a target program in the program list information according to a selecting strategy, and switching to and playing the target program.

A method for no-signal processing of a television, according to some embodiments of this disclosure, includes: sending a request for obtaining program list information to a network side when a program that is being played by a television shows “no signal”, wherein the request at least carries identification information of the program that is played by the television before no signal; then, receiving and displaying the program list information sent by the network side, wherein the program list information is program information determined by the network side according to the identification information and related to the program that is played by the television before no signal; and finally, determining a target program in the program list information selected by a user, or selecting a target program in the program list information according to a selecting strategy, and switching to and playing the target program. Therefore, according to the method for no-signal processing of a television, according to some embodiments of this disclosure, when the program that is being played by the television shows “no signal”, a user may select a target program for playing from recommended program list information according to his/her own interests, thereby avoid waiting for signal restoration for a long time, and improving user experience.

In some embodiments, determining a target program in the program list information selected by a user, or determining a target program in the program list information according to a selecting strategy and switching to and playing the target program in the step 103 includes:

switching to and playing the target program if the target program in the program list information selected by the user is detected in a preset time;

otherwise, selecting the target program in the program list information according to a selecting strategy and switching to and playing the target program.

When a program that is being played by a user shows “no signal”, a system will stay standby automatically for a period of time and then turn off the television, for example, the waiting time is generally set as 30-60s. In order to avoid the phenomenon of automatic standby or power-off of the television, in some embodiments of this disclosure, after a no-signal interface appears, a picture of the television is switched to a target program selected by the user when it is detected that the user selects the target program in a preset time; and when an action of selecting the target program by the user is not detected in the preset time, the target program in the program list information will be selected according to a selecting strategy, and the picture of the television will be switched to the target program automatically. Where, in order to avoid television standby and power-off, the preset time is set as being less than the waiting time, wherein the waiting time refers to time the television takes to enter in a standby state from a no-signal state. For example, the preset time may be 15-30s. The preset time is not specifically defined herein. Therefore, whether a user selects a target program or not can be determined according to the preset time, and whether the target program is selected according to a user selection or according to a selecting strategy can be determined in an effective time, thereby effectively improving user experience.

In some embodiments, the method, after determining the target program in the program list information selected by a user, further includes:

judging whether to further play the program after signal restoration or not when the signal is restored to be normal, switching to and playing the program after signal restoration if it is determined to further play the program after signal restoration, or switching to and playing the target program if it is not determined to further play the program after signal restoration.

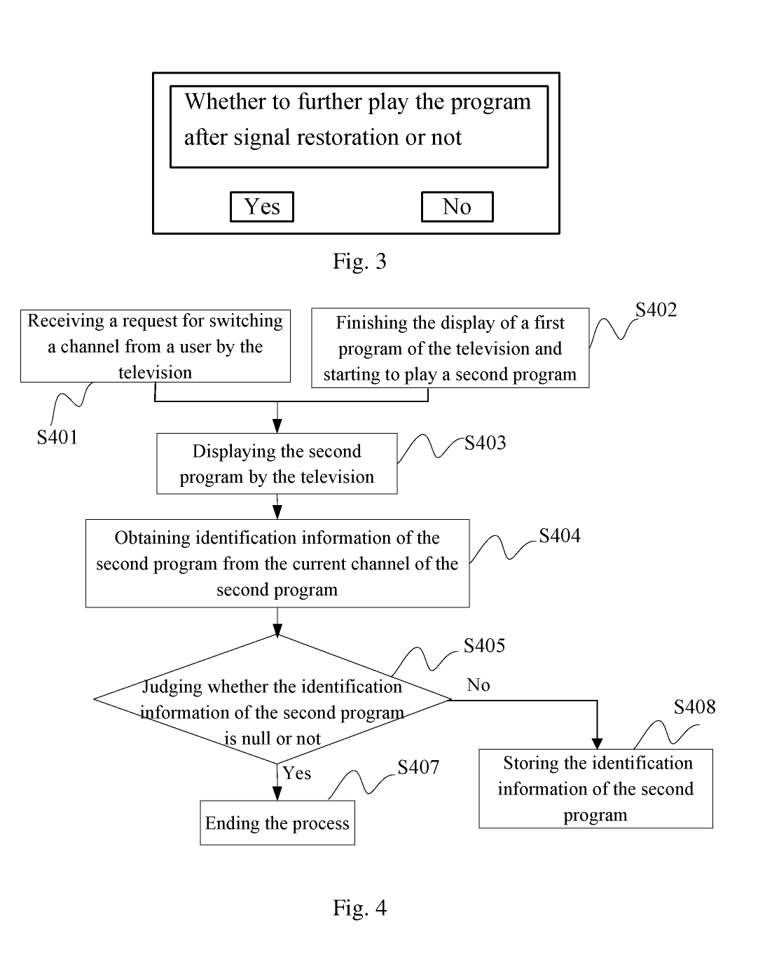

In some embodiments, when the signal is restored after a target program in the program list information selected by a user is determined and the target program is displayed, then whether to further play the program after signal restoration or not is judged, the program after signal restoration is switched to and played if it is determined to further play the program after signal restoration, otherwise, the target program is switched to and played. Or, when the signal is restored before the target program in the program list information selected by the user is determined and displayed, then whether to further play the program after signal restoration or not is judged, the program after signal restoration is switched to and played if it is determined to further play the program after signal restoration; otherwise, the target program is switched to and played.

Where, whether to further play the program after signal restoration or not is judged, a prompt interface may be displayed on a display screen of the television, as shown in FIG. 3, including a prompt dialog for whether selects to further play the program after signal restoration or not, an option “YES” and an option “NO”. The user can perform selection according to the prompt interface. Certainly, judging whether to further play the program after signal restoration or not may also be prompted in other ways. Therefore, the method for no-signal processing of a television, according to embodiments of this disclosure, may also include further determining whether the signal is restored or not after the user determines a target program; therefore, after considering various conditions comprehensively, the user experience is further improved in the case of normal playing after signal restoration is not affected.

In some embodiments, in the above method according to the embodiments of this disclosure, selecting the target program in the program list information according to a selecting strategy and switching to and playing the target program includes:

taking a first program listed in the program list information as a target program when the signal is not restored and the target program in the program list information selected by the user is not determined in a preset time, or randomly selecting any program in the program list information as the target program, and switching to and playing the target program.

In some embodiments, selecting a target program in the program list information according to a selecting strategy may include: taking a first program listed in the program list information as the target program; or randomly selecting any program in the program list information as the target program, where, a standard for random selection may be set according to actual situations, i.e., selecting according to key words of the target program, or selecting according to an arrangement position of the target program, etc., which are not specifically defined herein. After a television displays the program list information, and when the user does not perform selection in a preset time and the signal is not restored, the target program in the program list information may be selected according to a selecting strategy. Certainly, if the user does not select the target program in a preset time but the signal is restored, the television further plays the program after signal restoration.

In some embodiments, before the program that is being played by the television shows “no signal”, the method also includes:

storing program identification information corresponding to the program that is being played.

In some embodiments, when the television is playing a television program, in order to conveniently determine identification information of each program, it is necessary to store the program identification information corresponding to the program that is being played. Where, when the program identification information corresponding to the program that is being played is stored, the television program is switched in the next second, and when a next program is displayed, the program identification information corresponding to the program after switching is stored, thereby achieving a purpose of updating program information in real time, and facilitating the network side to determine the program that is being played. As shown in FIG. 4, a method, according to some embodiments of the present disclosure, for storing programs in a data storage area of a television includes:

It should be noted that, the program identification information corresponding to each program played by the television needs to be stored, where, only the program identification information corresponding to the program that is currently played may be stored, or while the program identification information corresponding to the program that is currently played is stored, the stored program identification information corresponding to a previous program is deleted. Where, when television programs are switched, the identification information of a program after switching may be stored according to a way shown in FIG. 4.

S401: carrying out step S403 if the television receives a request for switching a channel from a user;

S402, carrying out step S403 if a first program of the television is finished and a second program is started to play;

S403: displaying the second program by the television;

S404: obtaining identification information of the second program from the current channel of the second program;

Wherein the identification information may be obtained from EGP information of the current channel of the second program, or obtained in other ways, which are not specifically defined herein.

S405: judging whether the identification information of the second program is null or not, carrying out step S407 if the identification information of the second program is null; otherwise, carrying out step S406;

S406: storing the identification information of the second program;

Wherein the identification information may be stored in a stacking mode or according to a time sequence, or the identification information of the second program is stored and the identification information of the first program is deleted, which are not specifically defined herein.

S407: ending the process. Wherein, the identification information of the second program being null means that the second program that is currently played is in a no-signal state.

Wherein, the identification information may be a name of a program.

In some embodiments, when the program that is being played by the television shows “no signal” and a display device is in a non-networked state, the method further includes: entering into a no-signal standby state.

The method for no-signal processing of a television, according to this disclosure, will be described in detail through some embodiments.

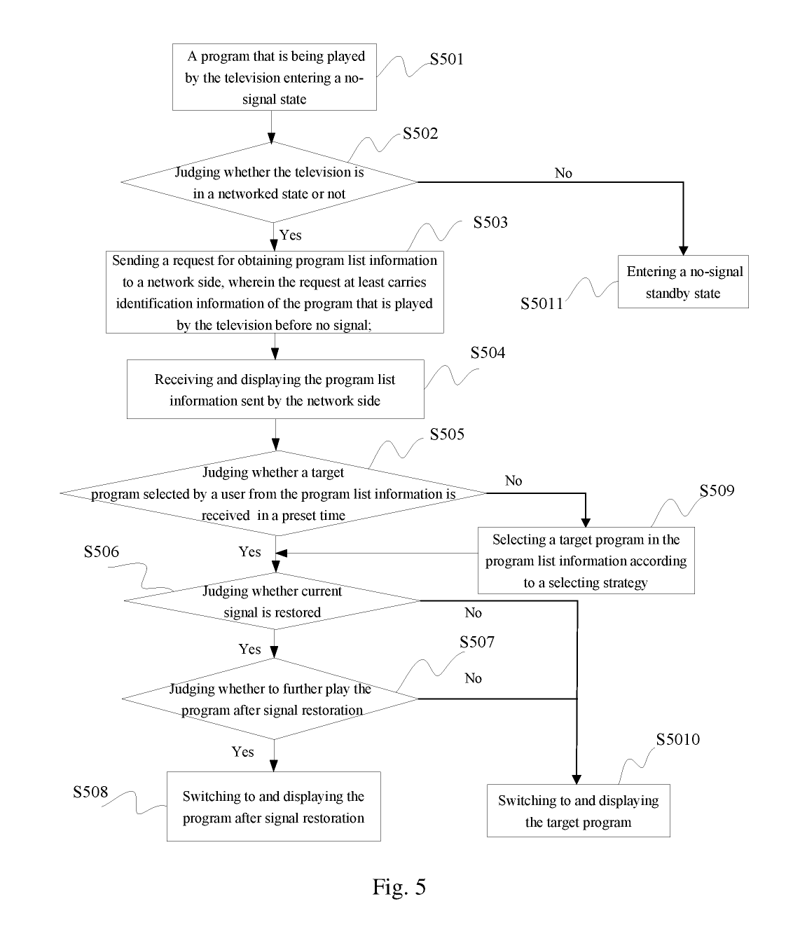

Referring to FIG. 5, the method for no-signal processing of a television, according to some embodiments of this disclosure, includes:

S501: determining a program that is being played by a television entering a no-signal state;

S502: judging whether the television is in a networked state or not, carrying out step S503 if the television is in a networked state, or otherwise, carrying out step S5011;

S503: sending a request for obtaining program list information to a network side, wherein the request at least carries identification information of the program that is played by the television before no signal;

S504: receiving and displaying the program list information sent by the network side, wherein the program list information is program information determined by the network side according to identification information and related to the program that is played by the television before no signal;

S505: judging whether a target program selected by a user from the program list information is received or not in a preset time, carrying out step S506 if the target program selected by the user from the program list information is received, or otherwise, carrying out step S509;

S506: judging whether the signal is restored from the current no-signal state or not, carrying out step S507 if the signal is restored, or otherwise, carrying out step S5010;

S507: judging whether to further play the program after signal restoration or not, carrying out step S508 if it is determined to further play the program after signal restoration, or otherwise, carrying out step S5010;

S508: switching to and displaying the program after signal restoration;

S509: selecting a target program in the program list information according to a selecting strategy, and carrying out step S506;

S5010: switching to and displaying the target program; and

S5011: entering into a no-signal standby state.

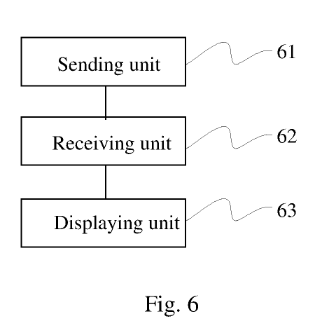

Based on the same inventive concept, referring to FIG. 6, some embodiments of this disclosure further provide a device for no-signal processing of a television, and the device includes:

a sending unit 61 configured to send a request for obtaining program list information to a network side when a program that is being played by a television shows “no signal”, wherein the request at least carries identification information of the program that is played by the television before no signal;

a receiving unit 62 configured to receive and display the program list information sent by the network side, wherein the program list information is program information determined by the network side according to the identification information and related to the program that is played by the television before no signal; and

a displaying unit 63 configured to determine a target program in the program list information selected by a user, or selecting the target program in the program list information according to a selecting strategy, and switch to and play the target program.

Optionally, the displaying unit 63 is configured to:

switch to and play a target program if the target program in the program list information selected by a user is detected in a preset time;

otherwise, select the target program in the program list information according to a selecting strategy and switch to and play the target program.

Optionally, the displaying unit 63, after determining the target program in the program list information selected by a user, is also configured to:

judge whether to further play the program after signal restoration or not when the signal is restored, switch to and play the program after signal restoration if it is determined to further play the program after signal restoration, or switch to and play the target program if it is not determined to further play the program after signal restoration.

Optionally, the displaying unit 63 is configured to select a target program in the program list information according to a selecting strategy, and switch to and play the target program by:

taking a first program listed in the program list information as a target program when the signal of the first program is not restored and the target program in the program list information selected by a user is not determined in a preset time, or randomly selecting any program in the program list information as the target program, and switching to and playing the target program.

Based on the same inventive concept, some embodiments of this disclosure also provide a smart television, including any device for no-signal processing of a television, provided by embodiments of this disclosure. The embodiments of the smart television may refer to the embodiments of the processing device for no signal, and the repeated parts are not detailed anymore.

Those skilled in the art should understand that the embodiments of this disclosure may provide a method, a system or a computer program product. Therefore, this disclosure may adopt the forms of complete hardware embodiments, complete software embodiments, or embodiments combining software and hardware. Moreover, this disclosure may adopt a form of a computer program product that is implemented on one or more computer available storage media (including but not limited to magnetic disk memories, optical memories, etc.) containing computer available program codes.

This disclosure is described with reference to flow diagrams and/or block diagrams of the method, the device (system), and the computer program product according to the embodiments of this disclosure. It should be appreciated that each flow and/or block in the flow diagrams and/or the block diagrams, and the combination of the flows and/or blocks in the flow diagrams and/or the block diagrams may be implemented by computer program instructions. These computer program instructions may be provided to a processor of a general-purpose computer, a dedicated computer, an embedded processor or other programmable data processing equipment to generate a machine to enable the instructions executed by the processor of the computer or other programmable data processing equipment to generate a device for achieving a designated function in one flow or multiple flows in a flow diagram and/or in one block or multiple blocks of a block diagram.

These computer program instructions may also be stored in a computer readable memory that can guide the computer or other programmable data processing equipment to work in a specific mode to enable the instructions stored in the computer readable memory to generate manufactured products including an instruction device which achieves a designated function in one flow or multiple flows in a flow diagram and/or in one block or multiple blocks of a block diagram.

These computer program instructions may also be loaded to the computer or other programmable data processing equipment to perform a series of operation steps on the computer or other programmable equipment so as to generate a processing achieved by the computer, so that the instructions executed on the computer or other programmable equipment provide steps for achieving a designated function in one flow or multiple flows in a flow diagram and/or in one block or multiple blocks of a block diagram.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A device for no-signal processing of a television, comprising:
a sending unit configured to send a request for obtaining program list information to a network side when a first program that is being played by a television is in a no-signal state, wherein the request at least carries identification information of the first program that is played by the television before no signal;
a receiving unit configured to receive and display the program list information sent by the network side, wherein the program list information is program information determined by the network side according to the identification information and related to the first program that is played by the television before no signal; and
a displaying unit configured to determine a target program in the program list information selected by a user, or selecting a target program in the program list information according to a selecting strategy, and switch to and play the target program.

2. The device according to claim 1, wherein the displaying unit is configured to:
switch to and play a target program if the target program in the program list information selected by a user is detected in a preset time;
otherwise, select a target program in the program list information according to a selecting strategy and switch to and play the target program.

3. The device according to claim 2, wherein the displaying unit is further configured to:
judge whether to further play the first program after signal restoration or not when the signal of the first program is restored after the target program in the program list information selected by the user is determined, switch to and play the first program after signal restoration if the first program after signal restoration is determined to be played further, or switch to and play the target program if the first program after signal restoration is not determined to be played further.

4. The device according to claim 2, wherein the displaying unit is configured to select the target program in the program list information according to a selecting strategy, and switch to and play the target program by:
taking a first listed program in the program list information as a target program when the signal of the first program is not restored and the target program in the program list information selected by a user is not determined in a preset time, or randomly selecting any program in the program list information as a target program, and switching to and playing the target program.

5. The device according to claim 1, wherein the sending unit is further configured to:
store program identification information corresponding to the first program before the first program that is being played by the television is in the no-signal state.

6. The device according to claim 2, wherein the preset time is less than a waiting time of the television, wherein the waiting time refers to time the television takes to enter in a standby state from the no-signal state.

7. A device for no-signal processing of a television, comprising a storage storing a computer readable program and at least one processor, wherein the at least one processor executes the computer readable program to:
send a request for obtaining program list information to a network side when a first program that is being played by a television is in a no-signal state, wherein the request at least carries identification information of the program that is played by the television before no signal;
receive and display the program list information sent by the network side, wherein the program list information is program information determined by the network side according to the identification information and related to the first program that is played by the television before no signal; and
determine a target program in the program list information selected by a user, or select a target program in the program list information according to a selecting strategy, and switch to and play the target program.

8. The device according to claim 7, wherein the at least one processor executes the computer readable program to determine a target program in the program list information selected by a user, or select the target program in the program list information according to a selecting strategy, and switch to and play the target program by:
switching to and playing a target program if the target program in the program list information selected by a user is detected in a preset time;
otherwise, switching to and playing a target program by selecting the target program in the program list information according to a selecting strategy.

9. The device according to claim 8, wherein the at least one processor further executes the computer readable program to:
judge whether to further play the first program after signal restoration or not when the signal of the first program is restored after the target program in the program list information selected by the user is determined, switch to and play the first program after signal restoration if the first program after signal restoration is determined to be played further, or switch to and play the target program if the first program after signal restoration is not determined to be played further.

10. The device according to claim 8, wherein the at least one processor executes the computer readable program to select a target program in the program list information according to a selecting strategy, and switch to and play the target program by:
taking a first listed program in the program list information as a target program when the signal of the first program is not restored and the target program in the program list information selected by a user is not determined in a preset time, or randomly selecting any program in the program list information as a target program, and switching to and playing the target program.

11. The device according to claim 7, wherein the at least one processor further executes the computer readable program to:
store program identification information corresponding to the first program before the first program that is being played by the television is in the no-signal state.

12. The device according to claim 8, wherein the at least one processor further executes the computer readable program so that the preset time is less than a waiting time of the television, wherein the waiting time refers to time the television takes to enter in a standby state from the no-signal state.

13. A method for no-signal processing of a television, comprising:
sending a request for obtaining program list information to a network side when a first program that is being played by a television is in a no-signal state, wherein the request at least carries identification information of the first program that is played by the television before no signal;
receiving and displaying the program list information sent by the network side, wherein the program list information is program information determined by the network side according to the identification information and related to the first program that is played by the television before no signal; and
determining a target program in the program list information selected by a user, or selecting a target program in the program list information according to a selecting strategy, and switching to and playing the target program.

14. The method according to claim 13, wherein determining a target program in the program list information selected by a user, or selecting the target program in the program list information according to a selecting strategy, and switching to and playing the target program, comprises:
switching to and playing a target program if the target program in the program list information selected by a user is detected in a preset time;
otherwise, switching to and playing a target program by selecting the target program in the program list information according to a selecting strategy.

15. The method according to claim 14, wherein after determining a target program in the program list information selected by a user, the method further comprises:
judging whether to further play the first program after signal restoration or not when the signal of the first program is restored, switching to and playing the first program after signal restoration if the first program after signal restoration is determined to be played further, and switching to and playing the target program if the first program after signal restoration is not determined to be played further.

16. The method according to claim 14, wherein selecting the target program in the program list information according to a selecting strategy, and switching to and playing the target program, comprises:
taking a first listed program in the program list information as a target program when the signal of the first program is not restored and the target program in the program list information selected by a user is not determined in a preset time, or randomly selecting any program in the program list information as a target program, and switching to and playing the target program.

17. The method according to claim 13, wherein before the first program that is being played by the television is in the no-signal state, the method further comprises:
storing program identification information corresponding to the first program that is being played.

18. The method according to claim 14, wherein the preset time is less than a waiting time of the television, wherein the waiting time refers to time the television takes to enter in a standby state from a no-signal state.
